(19) United States
(12) Patent Application Publication
(10) Pub. No.: US 2008/0301906 A1
(43) Pub. Date: Dec. 11, 2008

(54) Hinge structure with locking/unlocking function

(75) Inventors: Chia Jung Chiang, Sinjhuang City (TW); Huang Wen Lee, Sinjhuang City (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: JARLLYTEC CO., LTD.

(21) Appl. No.: 11/878,949

(22) Filed: Jul. 27, 2007

(30) Foreign Application Priority Data
Jun. 11, 2007 (TW) 096120934

(51) Int. Cl. E05D 7/06

(52) U.S. Cl. 16/241

(57) ABSTRACT

A hinge structure includes a bracket, which has a horizontal base panel and a vertical side panel, a first pivot set inserted through the side panel of the bracket and rotatably coupled to a support and having two elongated ribs protruded from one end of the pivot shaft and a guide groove defined between the elongated ribs, a supplementary contact member mounted on the pivot shaft of the first pivot set and having a contact lug disposed in parallel to and flush with the elongated ribs, and a second pivot set inserted through the horizontal base panel of the bracket and rotatably coupled to a mounting frame and having a two flat cut faces at two sides of the head of the pivot shaft thereof for stopping against the elongated rids of the pivot shaft of the first pivot set and the contact lug of the supplementary contact member such that the second pivot set is locked when the first pivot set is not turned to the predetermined angle, or unlocked for rotation when the first pivot set is turned to the predetermined angle.

### BACKGROUND OF THE INVENTION

1. Field of the Invention

The present invention relates to hinges and more particularly, to a hinge structure with locking/unlocking function in which the first pivot set is unlocked for free rotation when the second pivot shaft with the bracket are turned to a particular angle, for example, 90-degrees.

2. Description of the Related Art

A consumer electronic product with a lifting cover such as mobile computer, electronic dictionary, mobile video player, cell phone, etc., commonly uses a hinge to coupled the cover to the base member so that the cover can be opened from or closed on the base member. Therefore, the hinge determines the quality level of the product. A good hinge allows positive positioning, and does not cause noises during operation.

In recent years, advanced 3C electronic products have been continuously created. The conventional single hinge design to have the cover be turnable relative to the base member in a particular direction cannot satisfy the demand. Therefore, two pivot type hinge structures are developed for enabling the cover to be rotated relative to the base member when opened from the base member. Taiwan patent M304879 discloses a multiplex hinge entitled “HINGE STRUCTURE”, issued to the present inventor. According to this design, the hinge structure comprises a bracket, the bracket having a horizontal base panel and a side panel perpendicularly downwardly extending from one end of the horizontal base panel; a first pivot set, the first pivot set comprising a pivot shaft horizontally and rotatably inserted through the side panel of the bracket and rotatably coupled to a support, the pivot shaft of the first pivot set having two elongated ribs protruded from one end thereof and a guide groove defined between the two elongated ribs; and a second pivot set, the second pivot set comprising a pivot shaft vertically and rotatably inserted through the horizontal base panel of the bracket and rotatably coupled to a mounting frame, the pivot shaft of the second pivot set having a head at a bottom end thereof, the head of the pivot shaft of the second pivot set having two flat cut faces disposed at two opposite sides. When the first pivot set is rotated relative to the bracket to a zero angle position, the two elongated ribs of the pivot shaft of the first pivot set are stopped at one flat cut face of the head of the pivot shaft of the second pivot set to lock the second pivot set, prohibiting rotation of the second pivot set. When the first pivot set is rotated relative to the bracket to a predetermined angle, the head of the pivot shaft of the second pivot set is received in the guide groove between the two elongated ribs of the pivot shaft of the first pivot set to unlock the second pivot set, allowing rotation of the second pivot set.

According to the aforesaid design, the first pivot set is inserted through the side panel of the bracket and rotatably coupled to a support and has two elongated ribs protruded from one end of its pivot shaft and a guide groove defined between the elongated ribs, and the second pivot set is inserted through the horizontal base panel of the bracket and rotatably coupled to the mounting frame and has two flat cut faces at two sides of the head of its pivot shaft for stopping against the elongated rids of the pivot shaft of the first pivot set such that the second pivot set is locked when the first pivot set is not turned to the predetermined angle, or unlocked for rotation when the first pivot set is turned to the predetermined angle. Because the through hole on the side panel of the bracket through which the pivot shaft of the first pivot set is inserted is spaced behind the center of the side panel at a distance about 1.2 mm, and the elongated ribs may be not supported at the center of the flat cut faces of the second pivot set. In this case, the second pivot set and the mounting frame may be rotatable before the first pivot set is turned to the predetermined angle, for example, 90-degrees, causing an impact accident. Therefore, how to increase the contact area between the longitudinal ribs of the first pivot set and the cut faces of the second pivot set to prevent an unlocking accident is a problem of great concern.

### SUMMARY OF THE INVENTION

The present invention has been accomplished under the circumstances in view. According to one aspect of the present invention, the hinge structure comprises a bracket, which has a horizontal base panel and a side panel perpendicularly downwardly extending from one end of the horizontal base panel, a first pivot set, which comprises a pivot shaft horizontally and rotatably inserted through the side panel of the bracket and rotatably coupled to a support and a supplementary contact member mounted on the pivot shaft of the first pivot set for rotation with the pivot of the first pivot set, the pivot shaft of the first pivot set having two elongated ribs protruded from one end thereof and a guide groove defined between the two elongated ribs, the supplementary contact member comprising a contact lug extending from one side thereof and disposed in parallel to and flush with the elongated ribs, and a second pivot set, which comprises a pivot shaft rotatably inserted through the horizontal base panel of the bracket and rotatably coupled to a mounting frame, the pivot shaft of the second pivot set having a head at a bottom end thereof, the head of the pivot shaft of the second pivot set having two flat cut faces disposed at two opposite sides. When the first pivot set is rotated relative to the bracket to a zero angle position, the two elongated ribs of the pivot shaft of the first pivot set and the contact lug of the supplementary contact member are stopped at one flat cut face of the head of the pivot shaft of the second pivot set to lock the second pivot set, prohibiting rotation of the second pivot set. When the first pivot set is rotated relative to the bracket to a predetermined angle, the head of the pivot shaft of the second pivot set is received in the guide groove between the two elongated ribs of the pivot shaft of the first pivot set to unlock the second pivot set, allowing rotation of the second pivot set.

According to another aspect of the present invention, the hinge structure further comprises a third pivot set pivoted to the bracket. The third pivot set comprises a pivot shaft, a ring, and a L-shaped support. The pivot shaft of the third pivot set is inserted through a pivot hole on a second side panel of the bracket and the ring and pivotally fastened to a through hole of the L-shaped support.

According to still another aspect of the present invention, the pivot shaft of the second pivot set has a collar and a neck connected between the collar and the head the collar has two flat cut faces disposed at two opposite sides for stopping the two elongated ribs of the pivot shaft of the first pivot set.

According to still another aspect of the present invention, the first pivot set further comprises a cam wheel set. The cam wheel set comprises a movable member mounted on and rotatable with the pivot shaft of the first pivot set, and a fixed member affixed to the side panel of the bracket and disposed in contact with the movable member by means of a concave portion and a convex portion therebetween.

### BRIEF DESCRIPTION OF THE DRAWINGS

FIG. 1 is an exploded view of a hinge structure in accordance with the present invention.

FIG. 2 is an elevational assembly view of the hinge structure in accordance with the present invention.

FIG. 3 illustrates the first pivot set rotated to the predetermined angle and the second pivot set unlocked according to the present invention.

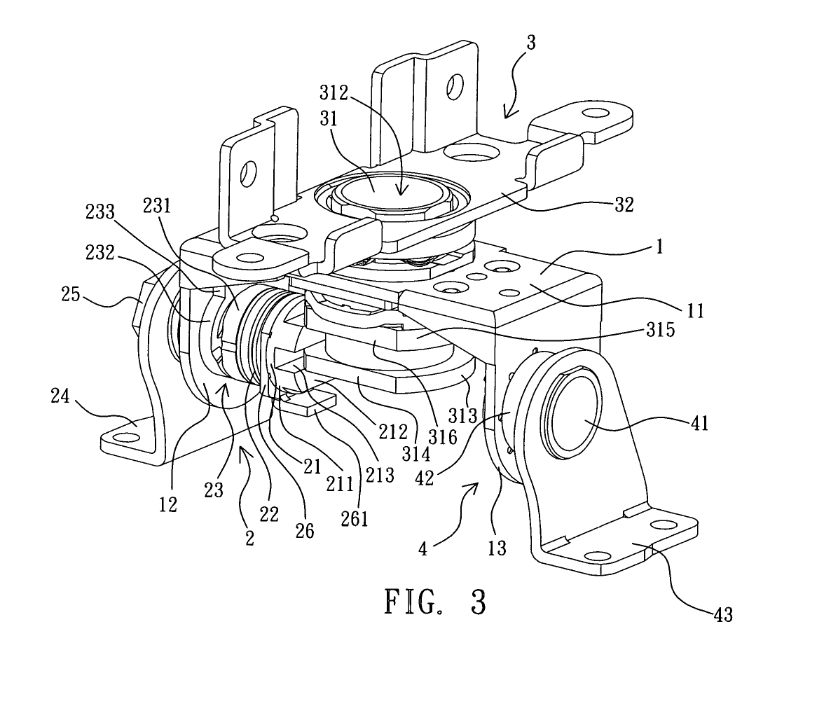

### DETAILED DESCRIPTION OF THE PREFERRED EMBODIMENT

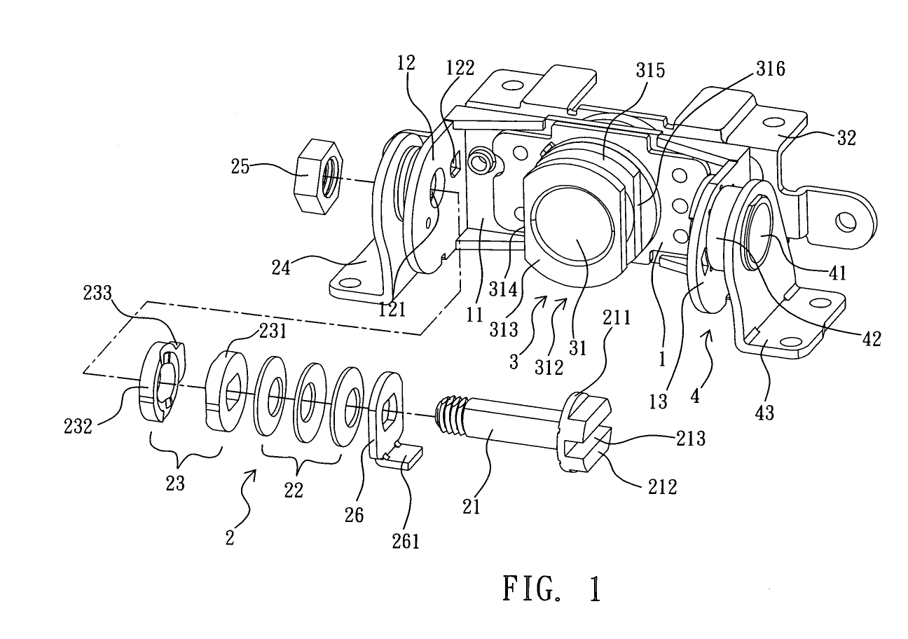

Referring to FIGS. 1˜3, a hinge structure in accordance with the present invention is shown comprised of a bracket 1, a first pivot set 2, and a second pivot set 3. A third pivot set 4 may be provided and pivotally mounted in the bracket 1.

The bracket 1 is directly stamped out of sheet metal. According to this embodiment, the bracket 1 is a [symbol] -shaped metal member having a horizontal base panel 11 and two vertical side panels 12 and 13 respectively downwardly extending from the two distal ends of the horizontal base panel 11 for supporting the first pivot set 2, the second pivot set 3 and the third pivot set 4. Alternatively, the bracket 1 can be a L-shaped metal member having only one side panel 12 perpendicularly downwardly extending from one end of the horizontal base panel 11 for supporting the first pivot set 2 and the second pivot set 3. The horizontal base panel 11 has an axle hole (not shown) for the passing of the pivot shaft 31 of the second pivot set 3. The side panel 12 has a pivot hole 121 at an eccentric location for the passing of the pivot shaft 21 of the first pivot set 2.

The first pivot set 2 is pivotally mounted in the side panel 12 of the bracket 1, having a pivot shaft 21 inserted in proper order through a plurality of spring members 22, a cam wheel set 23, the pivot hole 121 of the side panel 12 and a support 24, and then fastened up with a fastening member 25, for example, a screw nut. The pivot shaft 21 has a head 211 at one end. The head 211 has two elongated ribs 212 and a guide groove 213 defined between the two elongated ribs 212. To fit the eccentrically disposed pivot hole 121 of the side panel 12, the pivot shaft 21 of the first pivot set 2 is mounted with a supplementary contact member 26. As illustrated, the supplementary contact member 26 is a L-shaped plate member for rotation with the pivot shaft 21 of the first pivot set 2, having a contact lug 261 extending in direction subject to the extending direction of the elongated ribs 212 and arranged in parallel to and flush with the elongated ribs 212.

The spring members 22 can be coil springs, corrugated spring plates, or spring washers. The cam wheel set 23 is of the known art, comprising a movable member 231 and a fixed member 232 that work against each other by means of a concave portion and a convex portion therebetween. The cam wheel set 23 matches the compressing or expanding action of the spring members 22, providing the bracket 1 with a self-locking function, i.e., enabling the bracket 1 to be locked to the support 24. The fixed member 232 has a locating block 233 engaged into a locating hole 122 of the side panel 12 of the bracket 1.

The hollow pivot shaft 31 of the second pivot set 3 is inserted vertically upwardly from the bottom side of the bracket 1 in proper order through at least one spring member, a locating member, the axle hole of the horizontal base panel of the bracket, a stop member and a follower member, and then riveted to a mounting frame 32. As illustrated, the hollow pivot shaft 31 has a head 313 at one end, a collar 315 extending around the periphery, and a neck 312 connected between the head 313 and the collar 315. The head 313 has two flat cut faces 314 for stopping the elongated ribs 212 of the head 211 of the pivot shaft 21. The collar 315 has two flat cut faces 316 for stopping the elongated ribs 212 of the head 211 of the pivot shaft 21.

The third pivot set 4 has a pivot shaft 41 inserted in proper order through a pivot hole (not shown) on the side panel 13 of the bracket 1, and a ring 42, and then riveted to the L-shaped support 43, allowing rotation of the third pivot set 4 relative to the bracket 1.

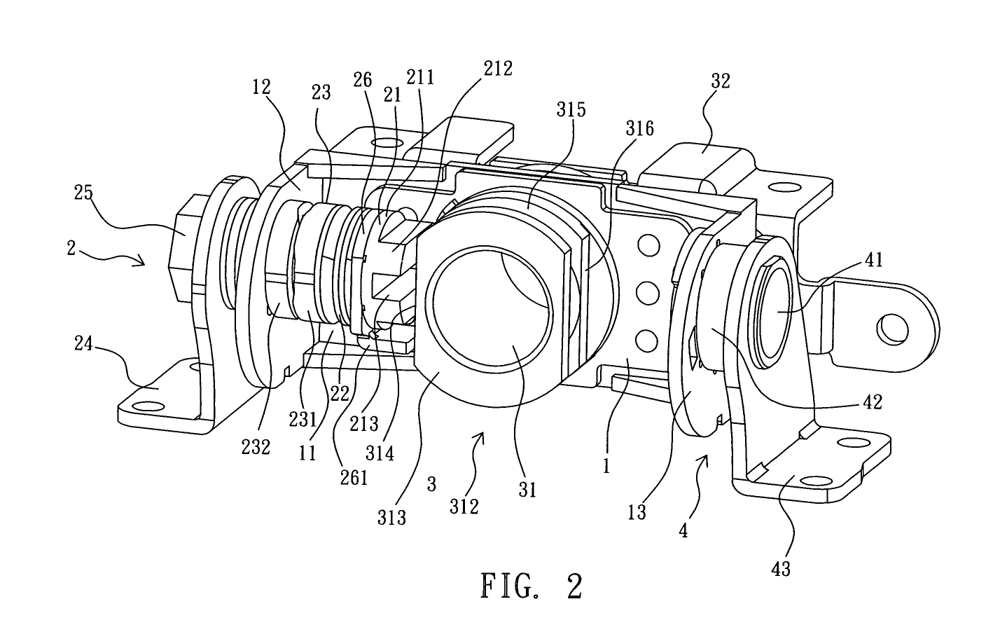

During application, the two support members 24 and 43 and the mounting frame 32 are respectively fixedly fastened to the base member and cover of an electronic device, for example, a mobile computer (not shown). When the electronic device is closed (0° angle), as shown in FIG. 2, the two elongated ribs 212 of the pivot shaft 21 and the contact lug 261 are respectively stopped at the flat cut faces 314 and 316, prohibiting rotation of the second pivot set 3. When opening the cover of the electronic device, the mounting frame 32 and the bracket 1 are turned with the cover of the electronic device relative to the base member. When the bracket 1 is turned relative to the supports 24 and 43 to a predetermined angle (90°), as shown in FIG. 5, the head 313 is received in the guide groove 213 between the two elongated ribs 212, i.e., the second pivot set 3 is unlocked and rotatable relative to the bracket 1. By means of the application of the present invention, the cover of the electronic device is openable relative to the base member in horizontal direction and rotatable in vertical direction when the cover is opened to a predetermined angle. Further, the first pivot set is provided with a supplementary contact member, which has contact lug arranged in parallel to and flush with the elongated ribs of the pivot shaft of the second pivot set to extend the contact area between the first pivot set and the flat cut faces of the second pivot set, thereby eliminating the drawback of the prior art design of limited contact area between the longitudinal ribs of the first pivot set and the cut faces of the second pivot set.

A prototype of hinge structure has been constructed with the features of FIGS. 1˜3. The hinge structure functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A hinge structure with locking/unlocking function comprising:
a bracket, said bracket having a horizontal base panel and a side panel perpendicularly downwardly extending from one end of said horizontal base panel;
a first pivot set, said first pivot set comprising a pivot shaft horizontally and rotatably inserted through said side panel of said bracket and rotatably coupled to a support and a supplementary contact member mounted on the pivot shaft of said first pivot set for rotation with the pivot of said first pivot set, the pivot shaft of said first pivot set having two elongated ribs protruded from one end thereof and a guide groove defined between said two elongated ribs, said supplementary contact member comprising a contact lug extending from one side thereof and disposed in parallel to and flush with said elongated ribs; and
a second pivot set, said second pivot set comprising a pivot shaft rotatably inserted through the horizontal base panel of said bracket and rotatably coupled to a mounting frame, the pivot shaft of said second pivot set having a head at a bottom end thereof, the head of the pivot shaft of said second pivot set having two flat cut faces disposed at two opposite sides; and
wherein when said first pivot set is rotated relative to said bracket to a zero angle position, the two elongated ribs of the pivot shaft of said first pivot set and the contact lug of said supplementary contact member are stopped at one flat cut face of the head of the pivot shaft of said second pivot set to lock said second pivot set, prohibiting rotation of said second pivot set; when said first pivot set is rotated relative to said bracket to a predetermined angle, the head of the pivot shaft of said second pivot set is received in the guide groove between the two elongated ribs of the pivot shaft of said first pivot set to unlock said second pivot set, allowing rotation of said second pivot set.

2. The hinge structure with locking/unlocking function as claimed in claim 1, further comprising a third pivot set pivoted to said bracket, said third pivot set comprising a pivot shaft, a ring and a L-shaped support, the pivot shaft of said third pivot set being inserted through a pivot hole on a second side panel of said bracket and said ring and pivotally fastened to a through hole of said L-shaped support.

3. The hinge structure with locking/unlocking function as claimed in claim 1, wherein the pivot shaft of said second pivot set has a collar and a neck connected between the collar and the head, said collar having two flat cut faces disposed at two opposite sides for stopping the two elongated ribs of the pivot shaft of said first pivot set.

4. The hinge structure with locking/unlocking function as claimed in claim 1, wherein said first pivot set further comprises a cam wheel set, said cam wheel set comprising a movable member mounted on and rotatable with the pivot shaft of said first pivot set, and a fixed member affixed to said side panel of said bracket and disposed in contact with said movable member by means of a concave portion and a convex portion therebetween.
